(19) United States
(12) Patent Application Publication
(10) Pub. No.: US 2017/0324281 A1
(43) Pub. Date: Nov. 9, 2017

(54) WIRELESS POWER TRNSFER DEVICE

(71) Applicant: NINGBO WEIE ELECTRONICS TECHNOLOGY LTD., Ningbo (CN)

(72) Inventor: Bingchen CHE, Ningbo, Zhejiang (CN)

(73) Assignee: NINGBO WEIE ELECTRONICS TECHNOLOGY LTD., Ningbo (CN)

(21) Appl. No.: 15/581,754

(22) Filed: Apr. 28, 2017

(30) Foreign Application Priority Data
May 6, 2016 (CN) 201610300042.6
Jul. 28, 2016 (CN) 201610619347.3

(51) Int. Cl. H02J 50/12; H01F 38/14; H01F 27/28; H02J 7/02; H02J 50/70

(52) U.S. Cl. CPC H02J 50/12; H02J 7/025; H02J 50/70; H01F 27/2885; H01F 38/14

(57) ABSTRACT

The present disclosure discloses a wireless power transfer device. A power transmitting coil (or a power receiving coil) is equally divided into N equivalents by configuring a primary-side compensation capacitor (or a secondary side compensation capacitor) to comprise N sub-compensation capacitors which are connected in the power transmitting coil (or the power receiving coil) in an equally distributed manner. With the distributed capacitance connection structure, it is possible to reduce the voltage across each coil segment of the power transmitting coil (or the power receiving coil), thereby reducing the coil-to-ground common mode current of the transmitting coil and the circulating current caused by the receiving coil.

### CLAIM OF PRIORITY AND CROSS-REFERENCE TO RELATED APPLICATION(S)

This application claims the benefit of Chinese Patent Application No. 201610619347.3, filed on Jul. 28, 2016, and Chinese Patent Application No. 201610300042.6, filed on May 6, 2016, which are incorporated herein by reference in entirety.

### FIELD OF THE INVENTION

The present disclosure relates to the field of wireless power transmission, and more particularly, to a wireless power transfer device.

### BACKGROUND OF THE INVENTION

A magnetic resonance type wireless charging system comprises a power transmitting end and a power receiving end. As shown in FIG. 1, the power transmitting end receives external power to generate a spatial magnetic field to transmit the energy to the power receiving end wirelessly.

In order to enable the power receiving end to induce a spatial magnetic field in a wider range to generate a voltage for electronic devices, one choice is to increase the size and inductance of the transmitting coil in the power transmitting end. However, increasing the size and inductance of the transmitting coil often needs to increase the turns and area of the transmitting coil. While according to the equation for the capacitance C=εS/D, increasing the area of the coil will increase the parasitic capacitance between the power transmitting coil and the ground. The relationship between the common mode current ICM and the parasitic capacitance C is ICM=CdV/dt. As shown in FIG. 2, the high frequency AC voltage Vs on the coil is more likely to generate a coil-to-ground common mode current ICM through this parasitic capacitance, which increases the EMC conduction interference. Further, when the size of the transmitting coil increases, the circumference of the coil will increase accordingly. If a high-frequency alternating current flows through the coil, the high-frequency alternating current is more likely to generate an electromagnetic wave, which increases the EMC radiation interference.

Another choice is to increase the magnetic field of the transmitting coil by increasing the alternating current in the transmitting coil, which will increase the voltage across the transmitting coil (V=jωLs·Is) and require a resonant capacitor Cs with a larger voltage-withstanding value to resonate with the transmitting coil Ls at the operating frequency point of the system. And with the increase of the voltage across the transmitting coil, the coil-to-ground common mode current will also be increased according to the above equation for the common mode current.

### BRIEF DESCRIPTION OF THE INVENTION

In view of the above, the present disclosure proposes a wireless power transfer device. The voltage of each segment of the power transmitting coil (or the power receiving coil) can be reduced by using a plurality of sub-compensation capacitors to segmentally compensate the power transmitting coil (or the power receiving coil), so as to reduce the coil-to-ground common mode current of the power transmitting coil (or the power receiving coil).

In a first aspect, it is provided with a wireless power transfer device according to the present disclosure comprising a power transmitting portion and a power receiving portion configured to receive energy transmitted from the power transmitting portion to generate a predetermined output voltage driving a load; wherein the power transmitting portion comprises an inverter circuit configured to receive a DC voltage signal to output an AC voltage signal; a power transmitting coil configured to receiving the AC voltage signal to transmit energy to the power receiving portion; and a primary-side compensation capacitor configured to compensating inductance of the power emitting coil so that a resonant frequency of a circuit comprising the power transmitting coil and the primary-side compensation capacitor coincides with an operating frequency of the wireless power transfer device; wherein the primary-side compensation capacitor comprises N sub-compensation capacitors coupled at different positions in the power transmitting coil in a distributed manner.

Preferably, the inductance of the power transmitting coil comprises leakage inductance and magnetizing inductance of the power transmitting coil.

Preferably, the N sub-compensation capacitors are coupled at different positions in the power transmitting coil to divide the power transmitting coil into N coil segments.

Preferably, the N sub-compensation capacitors are coupled at different positions in the power energy transmitting coil in an equally distributed manner to divide the power transmitting coil into N equivalent coil segments.

Preferably, the N sub-compensation capacitors have the same capacitance.

Preferably, each of the N sub-compensation capacitors and a corresponding coil segment of the power transmitting coil are configured to resonate at a frequency coinciding with the operating frequency of the wireless power transfer device.

In a second aspect, it is provided with a wireless power transfer device comprising a power transmitting portion and a power receiving portion comprising a power receiving coil and a secondary side compensation capacitor. Wherein the secondary side compensation capacitor is configured to compensate inductance of the power receiving coil so that a resonant frequency of a circuit comprising the power receiving coil and the secondary side compensation capacitor coincides with an operating frequency of the wireless power transfer device. Wherein the secondary side compensation capacitor comprising N sub-compensation capacitors coupled at different positions in the power receiving coil in a distributed manner.

Preferably, the inductance of the power receiving coil comprises leakage inductance and magnetizing inductance of the power receiving coil.

Preferably, the N sub-compensation capacitors of the secondary side compensation capacitor are coupled at different positions in the power receiving coil in an equally distributed manner to divide the power receiving coil into N equivalent coil segments.

Preferably, the N sub-compensation capacitors of the secondary side compensation capacitor have the same capacitance; and each of the N sub-compensation capacitors of the secondary side compensation capacitor and a corresponding coil segment of the power receiving coil are configured to resonate at a frequency coinciding with the operating frequency of the wireless power transfer device.

Preferably the power receiving portion further comprises a shield layer disposed between the power receiving coil and an electronic device.

Preferably, the shield layer comprises a magnetic shield layer disposed between the power receiving coil and the electronic device.

Preferably, the shield layer comprises a magnetic shield layer and a copper shield layer sequentially disposed between the power receiving coil and the electronic device.

Preferably, the magnetic shield layer comprises a hollow area and a solid area.

Preferably, the N sub-compensation capacitors are coupled with coil pins of the power receiving coil.

Preferably, the N sub-compensation capacitors are coupled in the power receiving coil in a distributed manner, and the N sub-compensation capacitors are disposed in the hollow area of the magnetic shield layer.

Preferably, the power receiving portion further comprises a rectifying circuit and a DC-DC voltage convertor. Wherein, electronic components of the rectifying circuit and the DC-DC voltage convertor are disposed in the hollow area of the magnetic shield layer; and the N sub-compensation capacitors are coupled with coil pins of the power receiving coil. Wherein part of the coil pins is coupled to the electronic components.

As stated above, in the wireless power transfer device according to the present disclosure, the power transmitting coil is equally divided into N equivalents correspondingly by configuring a primary-side compensation capacitor to comprise N sub-compensation capacitors coupled in the power transmitting coil in an equally distributed manner. Each of the N sub-compensation capacitors and a corresponding coil segment of the power transmitting coli are configured to resonate at a frequency coinciding with the operating frequency of the system. With above-described distributed capacitor connection structure, it is possible to reduce the voltage across each coil segment of the power transmitting coil, thereby reducing the coli-to-ground common mode current. However, the resonant frequency of total primary-side compensation capacitor and the power transmitting coil coincides with the operating frequency of the system, which may ensures high power transmission efficiency.

Furthermore, in the wireless power transfer device of the present disclosure, the secondary side compensation capacitors is configured to comprise N sub-compensation capacitors to divide the power receiving coil into N equivalents, which may also reduce the voltage across each segment of power receiving coil so as to reduce the circulating current caused by the power receiving coil in the metal or copper shield layer of the electrical device and improve power transmission efficiency.

### BRIEF DESCRIPTION OF THE DRAWINGS

FIG. 1 shows the structure of a prior art wireless charging system;

FIG. 2 shows a schematic diagram of a coil-to-ground common mode current;

FIG. 3 shows a schematic diagram of power transmitting coil portion in a wireless power transfer device according to the present disclosure;

FIG. 4 shows a circuit diagram of a first embodiment of the wireless power transfer device according to the present disclosure;

FIG. 5 shows a circuit diagram of a second embodiment of the wireless power transfer device according to the present disclosure;

FIG. 6 shows a circuit diagram of a third embodiment of the wireless power transfer device according to the present disclosure;

FIG. 7 shows a circuit diagram of a fourth embodiment of the wireless power transfer device according to the present disclosure;

FIG. 8 shows a circuit diagram of a fifth embodiment of the wireless power transfer device according to the present disclosure;

FIG. 9 shows a circuit diagram of a sixth embodiment of the wireless power transfer device according to the present disclosure;

FIG. 10 is a circuit diagram showing a seventh embodiment of the wireless power transfer device according to the present disclosure.

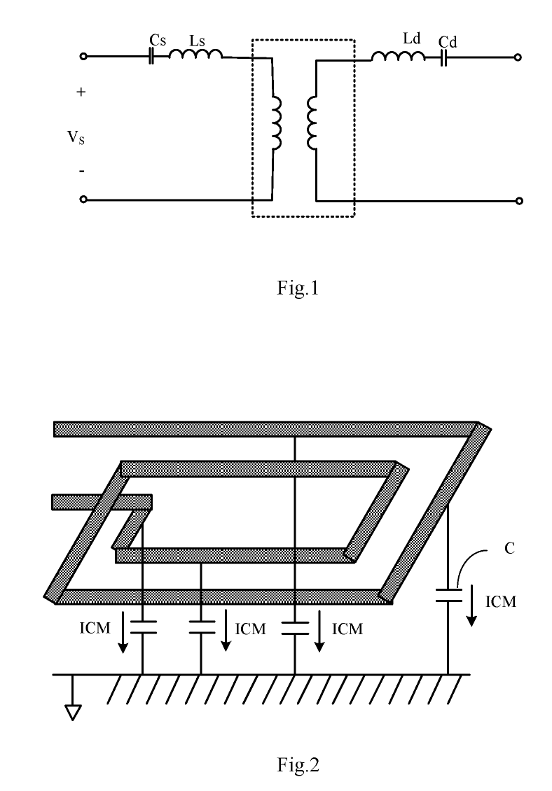

### DETAILED DESCRIPTION OF EMBODIMENTS OF THE INVENTION

Some preferable embodiments of the present disclosure will be described in conjunction with the drawings as below in details, but the present disclosure is not limited thereto.

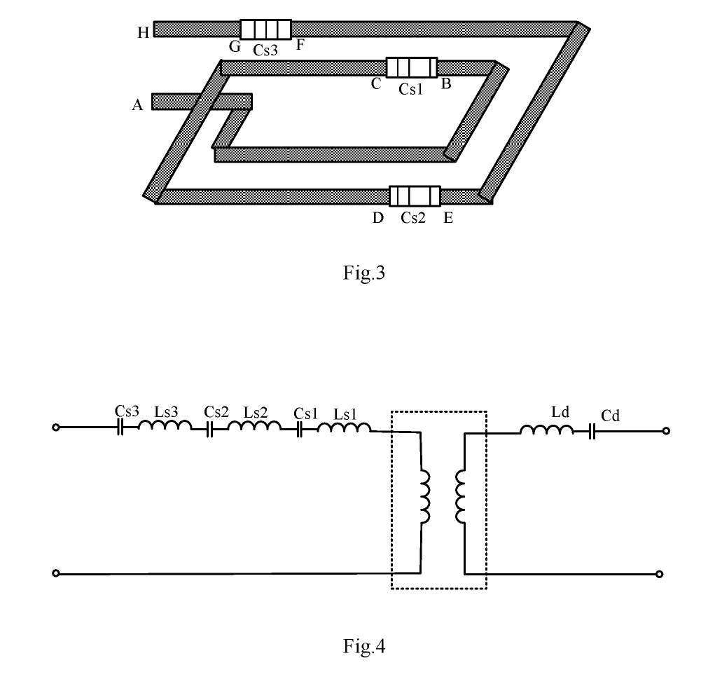

Referring to FIG. 3, there is shown a schematic diagram of a power transmitting portion in a wireless power transfer device according to the present disclosure. The power transmitting portion comprises an inverter circuit (not shown in FIG. 3) which is configured to convert an external DC voltage signal into an AC voltage signal for output, and the AC voltage signal is transmitted to the power transmitting coil.

The power transmitting coil portion further comprises a power emitting coil and a primary-side compensation capacitor for compensating the inductance of the power emitting coil so that the resonance frequency of a circuit comprising the power transmitting coil and the primary-side compensation capacitor coincides with an operating frequency of the system. Here, the inductance of the power transmitting coil comprises leakage inductance and magnetizing inductance in the power transmitting coil structure, the inductance of the power transmitting coil is substantially a constant value, the impedance of the compensation capacitor and the inductive reactance consisting of the magnetizing inductance and leakage inductance are configured to resonate for operation. The operating frequency of the system is the operating frequency of the wireless power transfer device, denoted as ω0, the operating frequency of the wireless power transfer device is configured in advance according to the circuit structure and efficiency requirements, for example, the frequency is preferably set to 6.78 MHz.

In the present embodiment, the primary-side compensation capacitor comprises N sub-compensation capacitors which are coupled at different positions in the power transmitting coil in a distributed manner, where N is a positive integer greater than 1. As shown in FIG. 3, the primary-side compensation capacitor comprises a sub-compensation capacitor Cs1, a sub-compensation capacitor Cs2 and a sub-compensation capacitor Cs3, with the case where N is 3.

Further, as shown in FIG. 3, the N sub-compensation capacitors are coupled at different positions in the power transmitting coil in an equally distributed manner to divide the power transmitting coil into N equivalent coil segment. The three sub-compensation capacitors shown in FIG. 3 divide the power transmitting coil into three equivalent coil segment, such as a coil segment AB, a coil segment CD and a coil segment DF. In order to optimize the parameters, the three sub-compensation capacitors have equal capacitance, and the capacitor Cs1 resonates with a coil segment of the power transmitting coil adjacent thereto such as the coil segment AB and the resonant frequency thereof is also 6.78 MHz which is the operating frequency of the system.

FIG. 4 shows a circuit diagram where the distributed power transmitting coil in FIG. 3 is applied to the wireless power transfer device. The wireless power transfer device in FIG. 4 further comprises a power receiving portion which including a power receiving coil Ld and a secondary side compensation capacitor Cd. As shown in FIG. 4, three sub-compensation capacitors are denoted as Cs1, Cs2, Cs3 and the three coil segments of transmitting coil are denoted as Ls1, Ls2 and Ls3, respectively. Assuming that the total inductance of the transmitting coil is Ls and the total capacitance of the compensation capacitors is Cs. According to the distributed structure shown in FIG. 4, the capacitance value of each sub-compensation capacitor is set as Cs1=Cs2=Cs3=3Cs and the inductance value of each coil segment is set as Ls1=Ls2=Ls3=Ls/3. In this way, the voltage across each coil segment is VLs/3.

In this way, the voltage across the coil Ls1 becomes VLs1=VLs/3. Since the sub-compensation capacitor Cs1 and the coil segment Ls1 resonate at the operating frequency, the equivalent impedance across the compensation capacitor Cs1 and the coil segment Ls1 is zero,

i.e., 1/jωCs1+jωLs1=0,

The sum of the voltage across the compensation capacitor Cs1 and the voltage across the coil Ls1 is 0 (i.e., VLs1+VCs1=0), the power through the coil can be transmitted to the maximum extent, and the transmission efficiency is high.

Similarly, the voltage across the coil Ls2 is VLs2=VLs/3. Similarly, the sub-compensation capacitor Cs2 and the coil segment Ls2 resonate at the operating frequency, and the sum of the voltage across the compensation capacitor Cs2 and the voltage across the coil Ls2 is zero. Similarly, the voltage across the coil Ls3 is VLs3=VLs/3. Similarly, the sub-compensation capacitor Cs3 and the coil segment Ls3 resonate at the operating frequency point, and the sum of the voltages across the compensation capacitor Cs3 and the voltage across the coil segment Ls3 is zero.

As can be seen from the above, compared with compensation the entire coil, by adopting a distributed compensation manner, the voltage across each piece of coil segment is reduced from original VLs to VLs/N in the distributed manner, then, according to the equation for common mode current mentioned in Background of the Invention, the coil-to-ground common mode current is also reduced to 1/N of the original value. The embodiment of the present disclosure is very suitable for the situation where the size of the transmitting coil is large. As the size of the transmitting coil is large, the common mode capacitance to the ground is large. The common mode current can be well reduced by reducing the leaping voltage in the coil by segmentally connecting the capacitors in series, which reduces EMC conduction interference.

It can be seen from the structure of the above-mentioned transmitting coil that the voltage-withstanding value of the compensation capacitor across the transmitting coil also changes from VLs to VLs/3, thus, the capacitor with smaller voltage-withstanding value can be adopted, which reduces the cost. And the decrease of the voltage across each coil segment further increases the reliability of the system.

It is to be noted that even if the parameter configuration of the distributed power transmitting coil does not adopt the above-described optimized equivalent scheme, for example, the N sub-compensation capacitors are connected at different positions in the power transmitting coil to divide the power transmitting coil into N coil segments. However, as long as it satisfies, as a whole, that the N-segment distributed inductors are connected in series: Ls1+Ls2+ . . . Lsn=Ls and N distributed capacitors are connected in series: Cs1=Cs2=Csn=NCs, the power transmitting efficiency of the system will not decrease, and the voltages across the distributed segmented coils will decrease, which reduces EMC conduction interference.

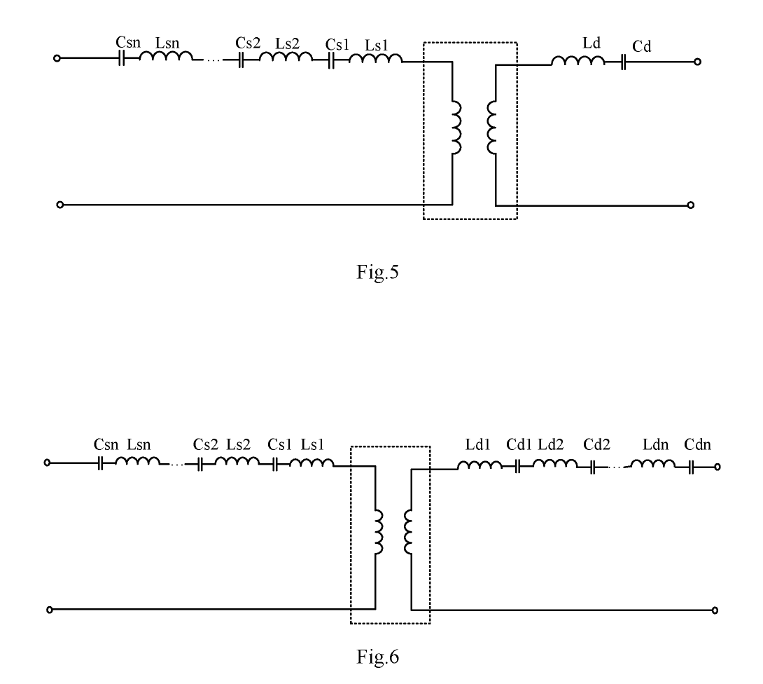

FIG. 5 shows a circuit diagram of a second embodiment of a wireless power transfer device according to the present disclosure. In the present embodiment, the transmitting coil portion comprises N sub-compensation capacitors (Cs1 . . . Csn), and accordingly, the power transmitting coil is equally divided into N equivalent coil segments (Ls1 . . . Lsn). Here, the capacitance values of the N sub-compensation capacitors may be equal or unequal to each other and the impedances of the N coil segments of the transmitting coil may be equal or unequal to each other, but the resonant frequency of the total impedance of the coil segments and the total impedance of the N sub-compensation capacitors coincides with the operating frequency of the system to maximize transmission efficiency. In this way, by performing segmental compensation on the transmitting coil, the voltage drop across the transmitting coil is greatly reduced, thereby reducing the common mode current. N is a positive integer greater than 1, and the number of sub-compensation capacitors is determined based on the requirements of the user for the common mode current together with the cost. For example, the number of sub-compensation capacitors may be increased in case of a harsh requirement for the common mode current, while the number of sub-compensation capacitors may be reduced if there is a limit on the cost.

FIG. 6 shows is a circuit diagram of a third embodiment of the wireless power transfer device according to the present disclosure. In the present embodiment, the power transmitting coil is identical to that of FIG. 5 and will not be described again. In the present embodiment, the secondary side compensation capacitor is configured to compensate the inductance of the power receiving coil so that the resonant frequency of the power receiving coil and the secondary side compensation capacitance coincides with the operating frequency of the system. The inductance of the power receiving coil comprises leakage inductance and magnetizing inductance in the power receiving coil structure.

In the present embodiment, the secondary side compensation capacitor comprises N sub-compensation capacitors (Cd1 . . . Cdn). The N sub-compensation capacitors are coupled at different positions in the power emitting coil in a distributed manner. Further, the capacitance values of the N sub-compensation capacitors are equal to each other and the N sub-compensation capacitors of the secondary side compensation capacitor are coupled at different positions in the power receiving coil in an equally distributed manner so as to divide the power receiving coil into N equivalent coil segments (e.g., Ld1 . . . Ldn), and each of the N sub-compensation capacitors and a coil segment corresponding thereto of the power receiving coil resonate (e.g., Cd1 and Ld1 resonate), and the resonant frequency thereof coincides with the operating frequency (6.78 MHz) of the system.

Similarly, for the secondary side, using the manner of above-described segmented receiving coil, the voltage drop across each coil segment of the receiving coil can be reduced, so that the coil-to-ground common mode current is reduced and the EMC interference of the system is reduced.

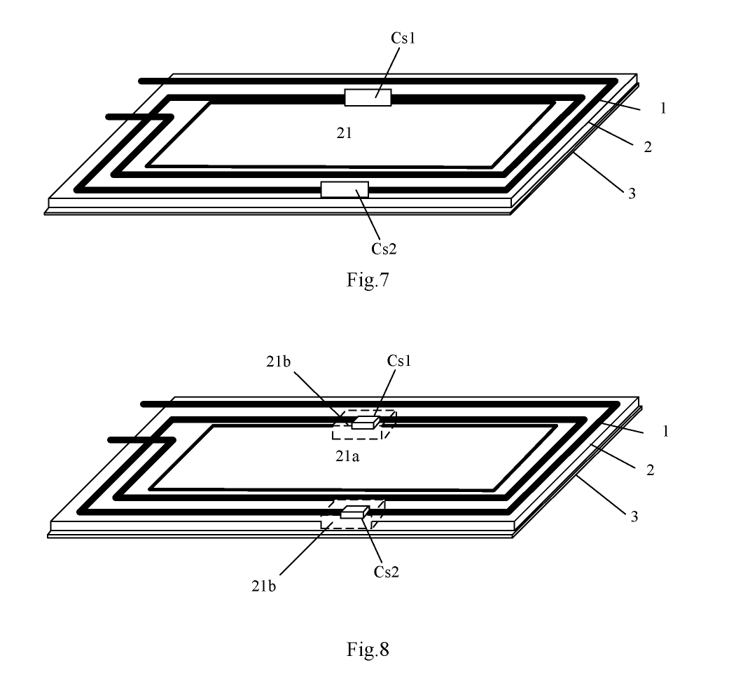

FIG. 7 shows a circuit diagram of a fourth embodiment of the wireless power transfer device according to the present disclosure. In the present embodiment, the power receiving portion further comprises a shield layer disposed between the power receiving coil 1 and an electronic device.

In a practical application, the shield layer comprises a magnetic shield layer 2 and a copper shield layer 3 which are sequentially disposed between the power receiving coil and the electronic device. The magnetic shield layer 2 may be a piece of magnetic sheet. The copper shield layer 3 may be a piece of copper sheet. As shown in FIG. 7, the magnetic shield layer 2 comprises a solid area and a hollow area 21, such as the hollowed portion 21 shown in FIG. 7. The sub-compensation capacitors CS1 and CS2 are connected in the middle of the power receiving coil to divide the power receiving coil into three equivalents.

It will be readily understood that in applications where the requirements are not harsh, the shield layer may comprise only a magnetic shield disposed between the power receiving coil and the electronic device.

Since the magnetic shield layer 2 is disposed between the power receiving coil 1 and the copper shield layer 3 (or metal sheet of the electronic device), the dielectric constant of the magnetic shield layer 2 is much higher than that of air (ε>10ε0) and the distance between the power receiving coil 1 and the copper shield layer 3 is short, the parasitic capacitor as generated will be very large, and the circulating current between the power receiving coil 1 and the copper shield layer 3 (or metal sheet) will be very large according to the calculation equation mentioned in the background of the invention. In the present embodiment, by adopting a structure dividing the power receiving coil 1 into multiple coil segments, it can be deduced that the voltage across each coil segment of the power receiving coil 1 will be greatly reduced according to the calculation process for the above-mentioned power transmitting coil, thereby reducing the circulating current caused in the copper sheet or metal by the power receiving coil, which can effectively improve the efficiency of power transmission.

FIG. 8 shows a circuit diagram of a fifth embodiment of the wireless power transfer device according to the present disclosure. The present embodiment is further modified based on the embodiment of FIG. 7. The hollow area 21 of the magnetic sheet comprises a hollowed portion 21a and a hollowed portion 21b, wherein the sub-compensation capacitors Cs1 and Cs2 are connected in the power receiving coil in a distributed manner, and the sub-compensation capacitors Cs1 and Cs2 are disposed in the hollow area 21 of the magnetic shield layer, such as the positions of hollowed portion 21b in FIG. 8. In this way, the power receiving coil 1 can be divided equally by the compensation capacitors Cs1 and Cs2 without increasing the overall thickness.

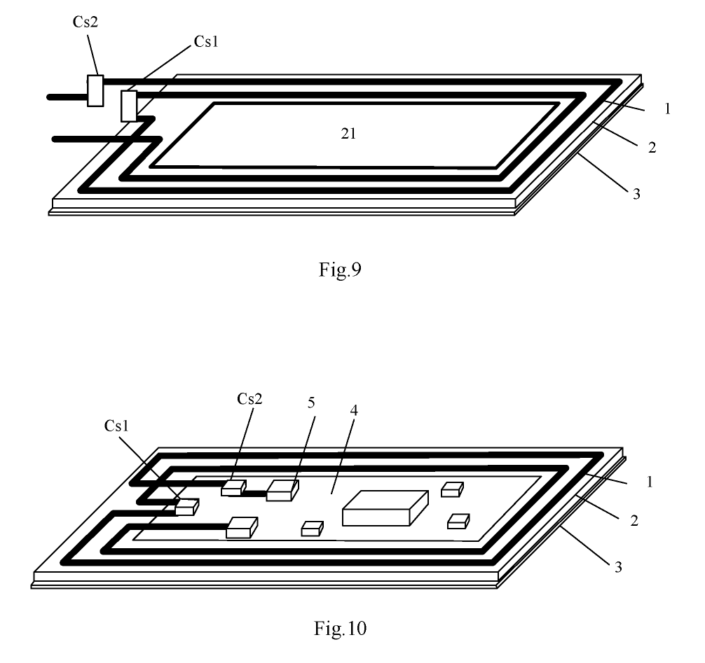

FIG. 9 shows a circuit diagram of a sixth embodiment of the wireless power transfer device according to the present disclosure. In the present embodiment, the N sub-compensation capacitors are coupled with coil pins of the power receiving coil. The coil pins are coupled with corresponding coil segment, and extend out of the magnetic shield layer 2. For example, the sub-compensation capacitors CS1 and CS2 in FIG. 9 are coupled with the coil pins, which facilitates the processing operation for the power receiving coil and the integration of the coil and the magnetic sheet.

FIG. 10 shows a circuit diagram of a seventh embodiment of the wireless power transfer device according to the present disclosure. In the present embodiment, the power receiving portion further comprises a rectifying circuit and a DC-DC voltage convertor, wherein the electronic components 5 of the rectifying circuit and the DC-DC voltage convertor are disposed in a hollow area 21 of the magnetic shield layer 2. Referring to the components 5 in FIG. 10, the sub-compensation capacitors such as CS1 and CS2 are coupled with the coil pins of the power receiving coil 1, and part of the coil pins of the power receiving coil 1 is coupled to the electronic components 5. In FIG. 10, the coil pins is disposed on a circuit board 5 on which the sub-compensation capacitors such as CS1 and CS2 and the electronic components 5 of the rectifying circuit and the DC-DC voltage convertor are disposed. In this way, the sub-compensation capacitors such as CS1 and CS2 and the electronic components 5 or part of the electronic components 5 that realize the power conversion function can be disposed on the circuit board 4 in the hollow area 21 of the magnetic shield layer, which can save space and facilitate the integration into the electronic device.

It should be noted that the above embodiments can be used in combination or separately, for example, the power transmitting coil is a distributed capacitor structure, or the power receiving coil is a distributed capacitor structure, or both the power transmitting coil and the power receiving coil are distributed capacitive structures. Those skilled in the art can choose according to demand.

The wireless power transfer device according to the preferred embodiment of the present disclosure has been described in detail above, but the circuits and the beneficial effects of the disclosure should not be considered to be only limited to the above description. The disclosed embodiments and the drawings can make a better understanding of the present disclosure. Therefore, the above-disclosed embodiments and the contents of the drawings are for a better understanding of the present disclosure and the present disclosure is not limited to the scope of present disclosure. Any substitution and improvement for the embodiments of the present disclosure made by those skilled in the art shall fall into the protection scope of the present disclosure.

I/We claim:

1. A wireless power transfer device, comprising
a power transmitting portion; and
a power receiving portion configured to receive energy transmitted from said power transmitting portion to generate a predetermined output voltage driving a load;
wherein said power transmitting portion comprises:
an inverter circuit configured to receive a DC voltage signal to output an AC voltage signal;
a power transmitting coil configured to receiving said AC voltage signal to transmit energy to said power receiving portion; and
a primary-side compensation capacitor configured to compensating inductance of said power emitting coil so that a resonant frequency of a circuit comprising said power transmitting coil and said primary-side compensation capacitor coincides with an operating frequency of said wireless power transfer device;
wherein said primary-side compensation capacitor comprises N sub-compensation capacitors coupled at different positions in said power transmitting coil in a distributed manner.

2. The wireless power transfer device as claimed in claim 1, wherein said inductance of said power transmitting coil comprises leakage inductance and magnetizing inductance of said power transmitting coil.

3. The wireless power transfer device as claimed in claim 1, wherein said N sub-compensation capacitors are coupled at different positions in said power transmitting coil to divide said power transmitting coil into N coil segments.

4. The wireless power transfer device as claimed in claim 1, wherein said N sub-compensation capacitors are coupled at different positions in said power energy transmitting coil in an equally distributed manner to divide said power transmitting coil into N equivalent coil segments.

5. The wireless power transfer device as claimed in claim 4, wherein said N sub-compensation capacitors have the same capacitance.

6. The wireless power transfer device as claimed in claim 5, wherein each of said N sub-compensation capacitors and a corresponding coil segment of said power transmitting coil are configured to resonate at a frequency coinciding with said operating frequency of said wireless power transfer device.

7. A wireless power transfer device, comprising:
a power transmitting portion; and
a power receiving portion comprising a power receiving coil and a secondary side compensation capacitor;
wherein said secondary side compensation capacitor is configured to compensate inductance of said power receiving coil so that a resonant frequency of a circuit comprising said power receiving coil and said secondary side compensation capacitor coincides with an operating frequency of said wireless power transfer device;
wherein said secondary side compensation capacitor comprising N sub-compensation capacitors coupled at different positions in said power receiving coil in a distributed manner.

8. The wireless power transfer device as claimed in claim 7, wherein said inductance of said power receiving coil comprises leakage inductance and magnetizing inductance of said power receiving coil.

9. The wireless power transfer device as claimed in claim 7, wherein said N sub-compensation capacitors of said secondary side compensation capacitor are coupled at different positions in said power receiving coil in an equally distributed manner to divide said power receiving coil into N equivalent coil segments.

10. The wireless power transfer device as claimed in claim 9, wherein said N sub-compensation capacitors of said secondary side compensation capacitor have the same capacitance; and
each of said N sub-compensation capacitors of said secondary side compensation capacitor and a corresponding coil segment of said power receiving coil are configured to resonate at a frequency coinciding with said operating frequency of said wireless power transfer device.

11. The wireless power transfer device as claimed in claim 7, wherein said power receiving portion further comprises a shield layer disposed between said power receiving coil and an electronic device.

12. The wireless power transfer device as claimed in claim 11, wherein said shield layer comprises a magnetic shield layer disposed between said power receiving coil and said electronic device.

13. The wireless power transfer device as claimed in claim 11, wherein said shield layer comprises a magnetic shield layer and a copper shield layer sequentially disposed between said power receiving coil and said electronic device.

14. The wireless power transfer device as claimed in claim 12, wherein said magnetic shield layer comprises a hollow area and a solid area.

15. The wireless power transfer device as claimed in claim 13, wherein said magnetic shield layer comprises a hollow area and a solid area.

16. The wireless power transfer device as claimed in claim 7, wherein said N sub-compensation capacitors are coupled with coil pins of said power receiving coil.

17. The wireless power transfer device as claimed in claim 14, wherein said N sub-compensation capacitors are coupled in said power receiving coil in a distributed manner, and said N sub-compensation capacitors are disposed in said hollow area of said magnetic shield layer.

18. The wireless power transfer device as claimed in claim 15, wherein said N sub-compensation capacitors are coupled in said power receiving coil in a distributed manner, and said N sub-compensation capacitors are disposed in said hollow area of said magnetic shield layer.

19. The wireless power transfer device as claimed in claim 14, wherein said power receiving portion further comprises a rectifying circuit and a DC-DC voltage convertor,
wherein, electronic components of said rectifying circuit and said DC-DC voltage convertor are disposed in said hollow area of said magnetic shield layer; and
said N sub-compensation capacitors are coupled with coil pins of said power receiving coil;
wherein part of said coil pins is coupled to said electronic components.

20. The wireless power transfer device as claimed in claim 15, wherein said power receiving portion further comprises a rectifying circuit and a DC-DC voltage convertor,
wherein, electronic components of said rectifying circuit and said DC-DC voltage convertor are disposed in said hollow area of said magnetic shield layer; and
said N sub-compensation capacitors are coupled with coil pins of said power receiving coil;
wherein part of said coil pins is coupled to said electronic components.
